(19) United States
(12) Patent Application Publication
(10) Pub. No.: US 2014/0358582 A1
(43) Pub. Date: Dec. 4, 2014

(54) Method for Generating a Selected Pool of Underwritten Insurance Policies

(71) Applicant: Innodata Synodex, LLC, Hackensack, NJ (US)

(72) Inventors: Richard D. Kemp, Edgewater, NJ (US); Sam Jensen, Larchmont, NY (US)

(21) Appl. No.: 13/907,245

(22) Filed: May 31, 2013

(51) Int. Cl. G06F 19/00

(52) U.S. Cl. CPC G06F 19/3431
USPC 705/3

(57) ABSTRACT

Methods, apparatuses, and computer readable media for generating a selected pool of underwritten insurance policies are provided. A normative risk element associated with data in a plurality of normalized medical reports is identified. A magnitude of the normative risk element is determined for each of the plurality of normalized medical reports. A plurality of risk performance standards are generated that correlate with the magnitude of the normative risk element for each of the plurality of medical reports, and a plurality of underwritten insurance policies are selected based on the plurality of risk performance standards or metrics, wherein the plurality of underwritten insurance policies comprise one of a synthetic or engineered pool of underwritten insurance policies.

### TECHNICAL FIELD

The present disclosure is generally directed to processing medical records, and more specifically to processing medical records for the purpose of associating underwritten insurance policies with each other based on the medical records.

### BACKGROUND

Collecting useful data from medical records is often tedious. Medical records related to a particular individual are often stored at disparate locations. Once these records are located, the task of gathering and analyzing the records is often labor-intensive. Typically, records must be organized and mined for data. Further, if the data is being gathered for input to an automated process, such as an automated insurance underwriting process, the records may also need to be formatted and data expressed in a normalized manner.

While current methods of processing medical records for automated processes can be useful, these methods are often informal and disorganized. Processing errors and other abnormalities often occur, which may cause automated processes that utilize the records to be inaccurate. At the very least, such inaccuracies can cause delays to automated processes when they are discovered.

Further, inaccurate methods of processing medical records can render impractical certain automated insurance underwriting processes that would require precise medical record data or reliable medical record analytics. For example, it is oftentimes advantageous for reinsurance or other purposes to group underwritten insurance policies into pools. However, due to the inaccurate processing methods currently utilized for underlying medical records, such pools are typically based on non-medical risk factors rather than medical record data or analytics.

### SUMMARY

Underwritten insurance policies can be more accurately grouped based on medical risk factors when an improved method of evaluating and tracking medical risk is employed. In particular, normalized medical record data obtained from medical records processed by a shared medical data platform may be utilized for generating selected (e.g., synthetic or engineered) pools of underwritten insurance policies.

Methods, apparatuses, and computer readable media for generating a selected pool of underwritten insurance policies are provided. A normative risk element associated with data in a plurality of normalized medical reports is identified. A magnitude of the normative risk element is determined for each of the plurality of normalized medical reports. A plurality of risk performance standards are generated that correlate with the magnitude of the normative risk element for each of the plurality of medical reports, and a plurality of underwritten insurance policies are selected based on the plurality of risk performance standards, wherein the plurality of underwritten insurance policies comprise one of a synthetic or engineered pool of underwritten insurance policies. The normative risk element may be further associated with additional data obtained as a result of an insurance underwriting process, and each of the plurality of underwritten insurance policies in the selected pool may be associated with at least one of the plurality of normalized medical reports.

In accordance with an embodiment, an underwritten insurance policy may be included or excluded from the selected pool based on a risk performance standard.

In accordance with an embodiment, the selected pool may be offered to an insurance underwriter to provide for preferred reinsurance rates or to provide for one of a securitized financial instrument or a financial service.

In accordance with an embodiment, the plurality of normalized medical reports may be structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions.

In accordance with an embodiment, the plurality of normalized medical reports may include normalized XML data or conform to one or more Association for Cooperative Operations Research and Development insurance data standards.

In accordance with an embodiment, the plurality of normalized medical reports may include normalized medical data and the normalized medical data may include one or more critical disease elements.

In accordance with an embodiment, a consensus underwriting score may be determined for the selected pool. The selected pool may be routed to a particular insurance underwriter based on a consensus underwriting score to provide for preferred reinsurance rates.

These and other advantages of the invention will be apparent to those of ordinary skill in the art by reference to the following detailed description and the accompanying drawings.

### BRIEF DESCRIPTION OF THE DRAWINGS

FIG. 1 is a workflow diagram showing an environment that may be used for generating a selected pool of underwritten insurance policies in accordance with an embodiment;

FIG. 2 is a flowchart of a process for medical record processing suitable for generating a selected pool of underwritten insurance policies in accordance with an embodiment;

FIG. 3A illustrates a page of a medical file in accordance with an embodiment;

FIG. 3B illustrates another page of a medical file in accordance with an embodiment;

FIG. 4 illustrates a data-point file in accordance with an embodiment;

FIG. 5 illustrates a coded file in accordance with an embodiment;

FIG. 6 is a flowchart of a process for generating a selected pool of underwritten insurance policies in accordance with an embodiment; and

FIG. 7 is a high-level block diagram of an exemplary computer that may be used for generating a selected pool of underwritten insurance policies.

### DETAILED DESCRIPTION

The assignment of insurance policies to reinsurers has been common, but generally has been performed by merely assigning blocks of underwriting tasks to reinsurers. Until now, such assignments have not typically been based on specific assessments of medical risk or medical engineering criteria. As such, typical pools of underwritten insurance policies are not useful for creating risk (e.g., securitized financial) instruments or other financial service devices that potentially could benefit policy holders, investors and traditional reinsurers.

When an improved method of evaluating and tracking medical risk is available, however, groups of underwritten insurance policies can be structured into pools having selected medical risk-based characteristics. A pool is an identifiable group of insurance policies specifically selected for certain characteristics of risk, including extraordinary risks. For example, in a financial service device based on a pool, an insurance company originator may service pooled policies for an established fee, set up a lock-box for collection of premiums and establish investment reserves for payment of claims. In general, losses would be generated from early deaths in the pool, and profits would be generated from longer lives in the pool.

A selected pool of underwritten insurance policies is generated in accordance with the embodiments herein. A selected pool (also referred to herein as a synthetic or engineered pool) includes a pool of underwritten insurance policies with one or more desired policies assigned into the structure. Alternatively, a synthetic or engineered pool of underwritten insurance policies may include a “notional” security that mimics the performance of a real pool of underwritten insurance policies.

In contrast to a pool backed with executed insurance policies, a synthetic pool can be created as an instrument that assumes characteristics of a real pool in terms of insured customers and medical conditions. A synthetic pool or notional pool is referenced against the performance of a real pool.

For example, a real pool (e.g., pool A) may have 10,000 insurance policies, each one of which may cover a patient who has had stage I breast cancer and is a 10-year survivor. A synthetic pool based on pool A would have the same characteristics as pool A (is notional as to Pool A), but there would be no actual insurance policies related to the synthetic pool. As such, multiple synthetic pools can be created from a real reference pool.

Similarly, an engineered pool combines the characteristics of a plurality of real pools. For example, an engineered pool may be created by combining 50% of pool A above with 50% of another pool (e.g., pool B) that only includes patients who have immediate parents and grandparents who have lived longer than 90 years of age, except for accidental death. As such, in the engineered pool, the adverse risk of the breast cancer in pool A may be offset by the positive risk of the long-lived genes in pool B.

Therefore, a synthetic or engineered pool of underwritten insurance policies may be created to reproduce the medical risk behavior and other characteristics of one or more real or prototypical insurance policies. Further, a synthetic or engineered pool may mimic the medical risk behavior of a general population (i.e., normative risk behavior). Such a normative synthetic pool may be based on an exact proportion of disease within a general population. Moreover, a preferred synthetic pool may reflect a lower amount of disease than a general population, while an impaired synthetic pool may reflect particular impairments (e.g., one or more diseases) that are known to increase medical risk.

While there are individuals who have certain medical risks that are typically declined by policy reinsurers, synthetic or engineered pools of underwritten insurance policies for such individuals potentially could be assumed by investors (given a return on capital) if medical risk behavior can be accurately assessed. As such, a purpose-built synthetic or engineered pool generated based on medical risk characteristics of underwritten insurance policies may be created to provide for a securitized financial instrument or another financial services device. In one example, a structured fixed-income investment based on an engineered pool may be structured such that the originator (i.e., the underwriter) retains responsibility for policy servicing (e.g., regarding claims) and customer billing, while the most significant risk is offered to investors in exchange for a yield on the securities issued. In particular, investors could be offered a security based on an engineered pool of long-term risk insurance policies that hinges on improvements in medical research and technology (e.g., new treatments and drug therapies), which may improve life expectancy for certain diseases or enable a cure that renders invalid present-day assumptions at some point during the life of the security. Other engineered pools may be based on pools of insureds having a disease that may have future life extension drugs or cures, pools of insureds having particular lifestyles or non-medical risks (e.g. pools of vegetarians, runners etc.), pools of insureds having balanced risks (certain percentages of disease that match the overall population), disease specific pools (e.g., for investor bets on technology breakthroughs for specific diseases), genetically screened pools, combined life and long-term-care pools and pools including tranches having different risk levels (e.g., higher risk, higher return tranches).

In accordance with the various embodiments, the term medical record processing as disclosed herein includes generating a medical report with data from an individual's medical records. Relevant data from medical record files is first extracted and then normalized based on standardized codes (e.g., ICD-10-CM disease and ICD-10-PCS procedure codes) or synthetic codes based on multiple variables (e.g., combinations of medical conditions, pain scales, lists of values or measurements). The generated medical report then may be formatted for input to an automated insurance underwriting process and other applications that require precise underlying medical record data or reliable medical record analytics. As such, in the various embodiments herein each underwritten insurance policy correlates with at least one medical report that is based on data from an individual's medical records.

In one embodiment, the process of generating a synthetic or engineered pool of underwritten insurance policies includes generating a plurality of medical reports. The process of generating a synthetic or engineered pool of underwritten insurance policies may include electronic data record processing for insurance underwriting processes. Moreover, the embodiments provide medical reports including normalized categories and formats that can be integrated with other medical record analyses and predictive models, including models for predicting disease trends (e.g., for life, health and disability insurance underwriting).

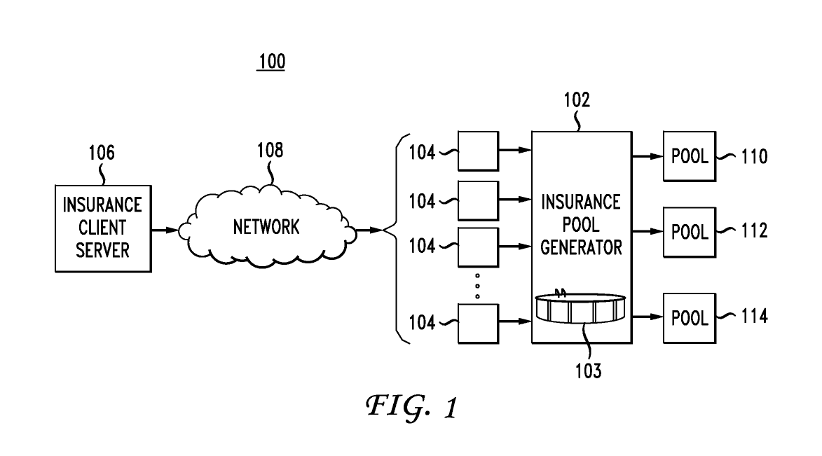

FIG. 1 is a workflow diagram showing an environment that may be used for generating a selected pool of underwritten insurance policies in accordance with an embodiment. In environment 100, insurance pool generator 102 is configured to receive and/or store (via database 103) a plurality of underwritten insurance policies 104, (e.g., each based on one or more medical reports) from an insurance client server 106. For example, insurance pool generator 102 may be in communication with insurance client server 106, which may be configured to manage medical record processing and generate the plurality of underwritten insurance policies 104, via network 108. Network 108 may be a private network (e.g., a company or healthcare provider intranet), a public network (e.g., the public Internet) supporting secure transmissions of machine-readable or imaged (e.g., PDF format) medical files or, alternatively, a combination of networks.

Insurance pool generator 102 is then further configured to generate one or more selected pools of underwritten insurance policies. In order to generate such pools, as described in detail below, insurance pool generator 102 may be configured to perform functions including identifying a normative risk element associated with data in a plurality of normalized medical reports, determining a magnitude of the normative risk element for each of the plurality of normalized medical reports, generating a plurality of risk performance standards that correlate with the magnitude of the normative risk element for each of the plurality of medical reports and selecting a plurality of underwritten insurance policies based on the plurality of risk performance standards.

In an embodiment, insurance pool generator 102 may select underwritten insurance policies to generate synthetic or engineered pools, e.g., pools 110, 112 and 114, that mimic a desired medical risk behavior. For example, insurance pool generator 102 may generate pool 110 to mimic the medical risk behavior of a normative synthetic pool, pool 112 to mimic the medical risk behavior of a preferred synthetic pool and pool 114 to mimic the medical risk behavior of an impaired synthetic pool.

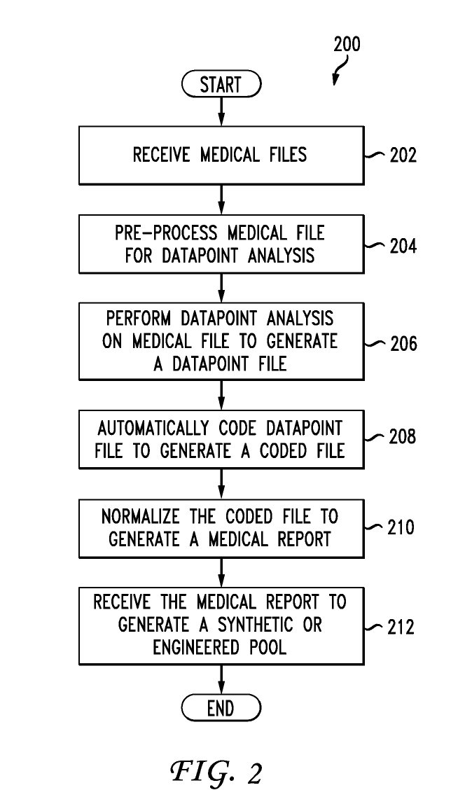

FIG. 2 is a flowchart of a process for medical record processing suitable for generating a selected pool of underwritten insurance policies in accordance with an embodiment. Process 200 presents methods employed for medical record processing. One skilled in the art will note that while the methods presented herein are exemplary, the following should not be considered as limiting as far as the particular techniques of medical record processing that may be employed. For example, one exemplary but not limiting medical record processing approach is the approach described in U.S. patent application Ser. No. 13/474,222, entitled “Medical Record Processing”, which is incorporated herein by reference.

In process 200, data point analysis is performed on a medical file to generate a data-point file, the data-point file is automatically coded to generate a coded file and the coded file is normalized to generate a medical report. For example, a medical file is received at a workflow manager at 202. At 204, the medical file is pre-processed for data-point analysis. For example, pre-processing may include removing non-relevant information from the medical file, such as regulatory or personal information. At 206, data point analysis is performed on the medical file to generate a data-point file. In one embodiment, data point analysis may be performed based on a predefined data point specification. For example, the data point specification may be based on one or more coding standards such as CPT, MeSH, MIB, ICD-10, ICD-10-PCS or ICD-10-CM. Performing data point analysis also may include identifying probable errors in the medical file (e.g., clearly erroneous notations of diagnoses or prescribed medications), and correcting such erroneous data.

The data-point file is automatically coded to generate a coded file at 108. For example, the data-point file may comprise a plurality of data-points and automatically coding the data-point file (e.g., via a coding engine) may comprise assigning one or more CPT, MeSH, MIB, ICD-10, ICD-10-PCS or ICD-10-CM codes or, alternatively, synthetic codes to the data-points. At 110, the coded file is normalized to generate a medical report. In one embodiment, the automatic coding at 108 may be based at least in part on feedback from one or more prior normalizations.

At 212, the medical report is received, such as via a secure client upload (e.g., either via a network or a direct connection), to generate a synthetic or engineered pool of underwritten insurance policies based on one or more medical reports. In one embodiment, a correlation may be determined between the coded file and mortality or life expectancy data, and the correlation may be provided to the automated insurance underwriting process (e.g., along with the medical report). For example, a life expectancy prediction may be determined based on the correlation. In one embodiment, mortality data may be expressed as one or more mortality risk (MR) values that may be automatically provided in association with the medical report.

In another embodiment, a correlation may be determined between the coded file and reported individual or group symptoms or medical test results. The correlation may then be provided to the automated insurance underwriting process for predicting future disease trends. For example, a heat map of individual or group medical conditions, diseases or symptoms may be generated based on a plurality of coded files provided to the automated insurance underwriting process. A heat map of individual or group medical conditions may include a list or graphical representation of critical or important medical conditions that determine insurability. The list or graphical representation may be grouped by type of disease or other risk factors.

In one embodiment, one or more normalized data sources may be used to determine classifications (e.g., low, moderate, high) underlying a list or graphical representation. Moreover, a heat map may be presented in the form of MR values or expressed in the form of insurance underwriters Table Risk (e.g., risk determined from mortality tables or actuarial tables). For example, insurance Table Risk typically includes range designations (e.g., Preferred Plus, Preferred, Standard Plus, Standard) and various tables of increasing risk and premium surcharges.

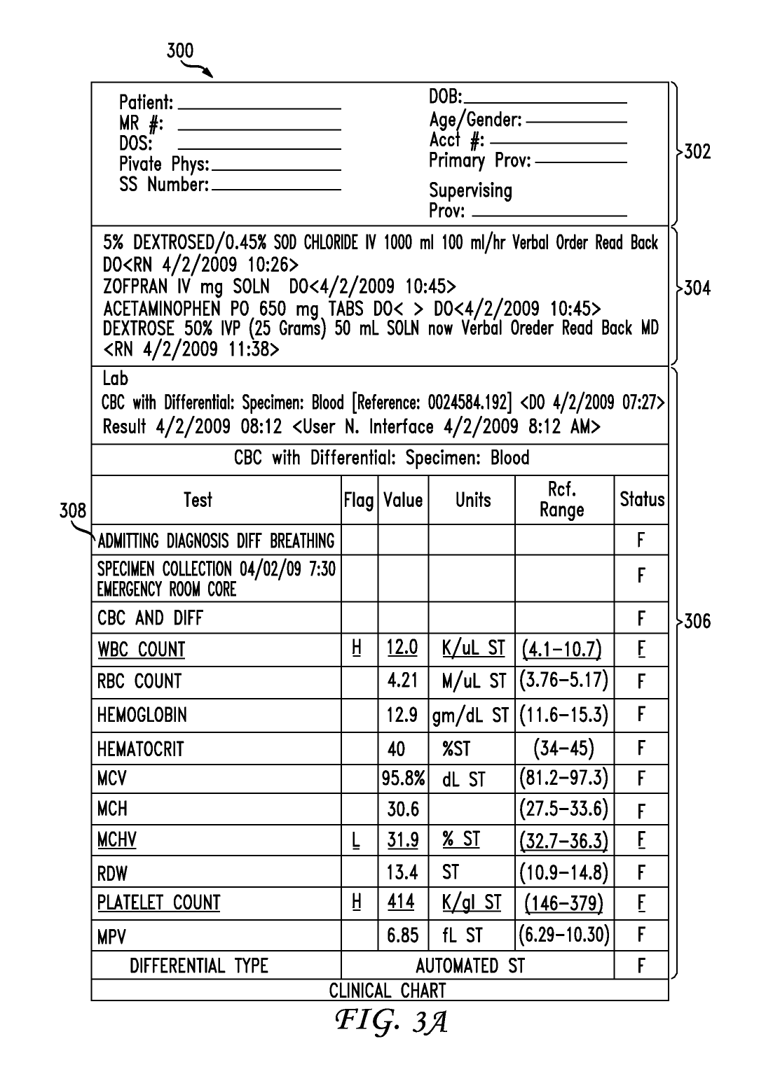

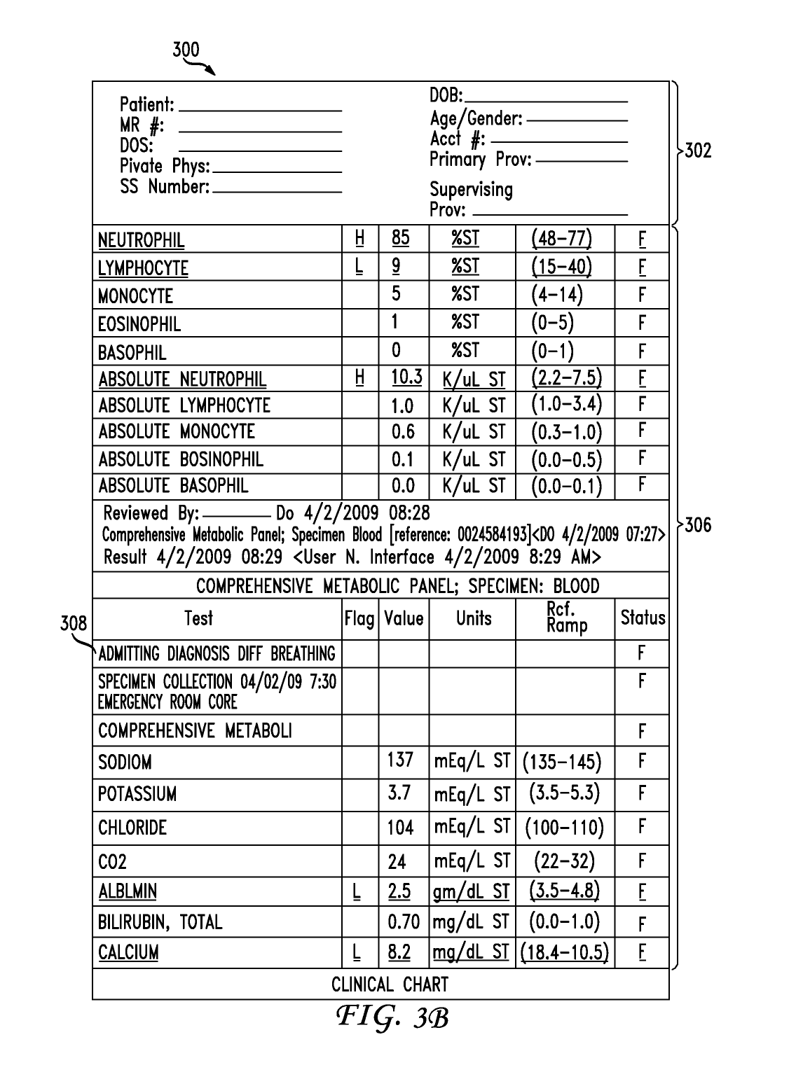

In one embodiment, medical files may include raw data that can be processed to generate formatted medical reports, including medical reports that are useful for automated life, health or disability insurance underwriting processes such as generating synthetic or engineered pools of underwritten insurance policies. FIGS. 3A and 3B illustrate pages of a medical file in accordance with an embodiment. For example, medical file 300 may contain patient information 302, including address and billing information for an individual. Medical file 300 may also contain data associated with doctor visits including, treatments and prescribed medications 304, test results 306, diagnoses 308, and other data. Medical file 300 also may contain additional information, such as regulatory, administrative or general medical data.

A workflow manager may coordinate steps for processing a medical file 300 to generate a medical report. For example, a workflow manager may coordinate the pre-processing of a medical file 300 by providing medical file 300 (e.g., a medical file stored in a database) to a pre-processing function. A pre-processing function may include ordering (e.g., organizing and/or classifying), typing and/or sorting medical file 300 for subsequent processing steps. For example, ordering, typing or sorting operations for a medical file may include converting data (e.g., from machine-readable to human-readable formats, or vice versa), matching data with a particular individual or a plurality of individuals, and extracting data (e.g., regulatory or boilerplate sections) that is not relevant to subsequent processing.

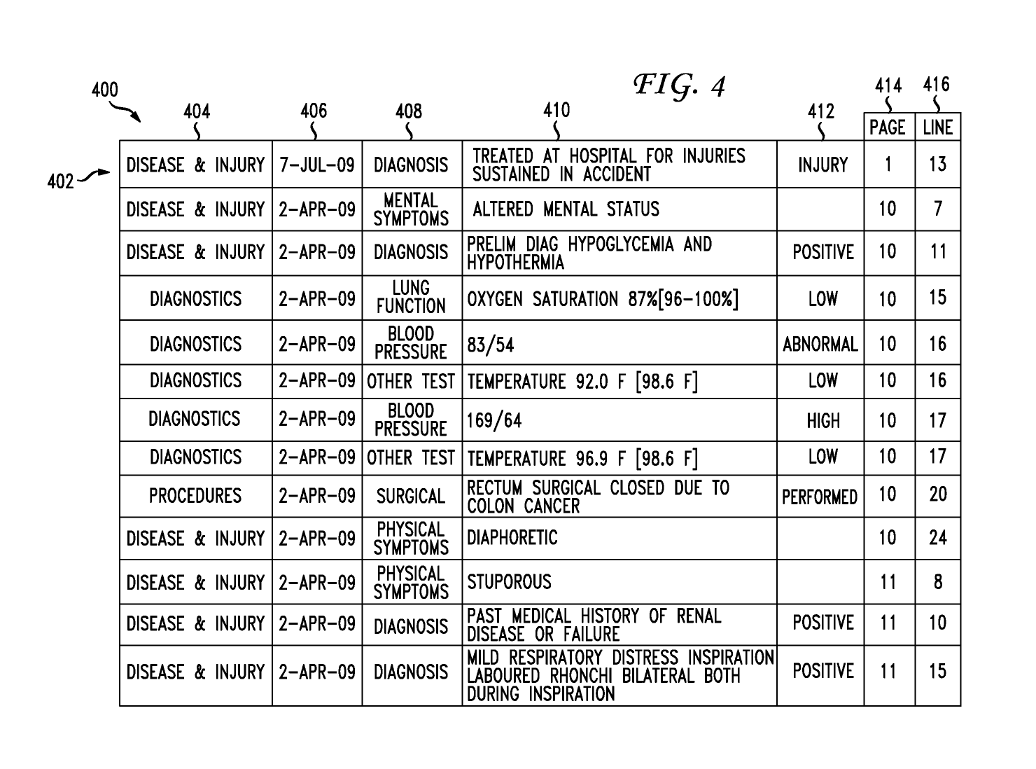

The pre-processed file may be provided to an analysis function for data-point analysis. An analysis function may include data-point analysis operations for analyzing medical file 300 based on one or more data-points to generate a data-point file. A data-point is an extraction of particular data from a medical record in accordance with a specification. The format for data-points may be controlled for consistency, readability and relevancy to medical importance. As shown in FIG. 4, data-point file 400 may be formatted to include one or more data points 402 containing columns for data point descriptions 404, dates-of-entry 406, subject matter 408 (e.g., diagnosis, test, procedure), actions performed/notations 410, assessments 412 and page 414 and line 416 numbers corresponding to the pages/lines containing the data point information in the original medical file 300.

If the data point file is determined to comply with QA standards, the data point file may be provided for coding according to one or more medical record coding standards.

A coding engine may be configured to automatically code a data point file (e.g., based on one or more medical record coding standards, such as CPT, MeSH, MIB, ICD-10, ICD-10-PCS, ICD-10-CM, etc., or synthetic codes) to generate a coded file. For example, a coding engine may be configured analyze a data-point file to identify particular data points, such as data points that are undefined (e.g., data points that do not include a coded entry for a medical condition or diagnosis). A coding engine then may employ search algorithms to determine codes for the particular data points, e.g., to determine a preliminary classification (i.e., a probability ranking) of codes for particular data points based on data analysis (e.g., diagnosis correlation) criteria. For example, a preliminary classification of a particular data point of a data-point file may include rankings of codes that are probable matches for a given diagnosis, wherein the highest ranked code may indicate the best probable match for the given diagnosis. The best probable match then may be included as a final classification for the diagnosis in a coded file.

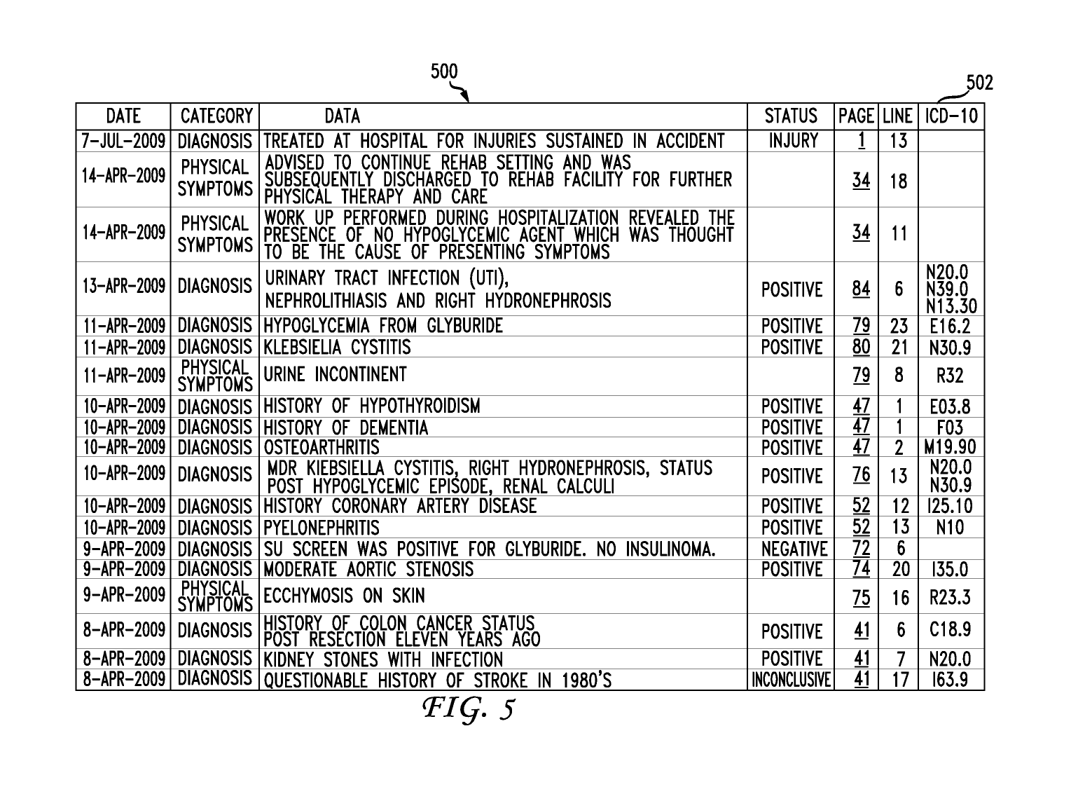

FIG. 5 illustrates a coded file wherein the data-points are coded according to one or more medical record coding standards. For example, coded file 500 may include a column 402 wherein one or more standard medical codes (such as CPT, MeSH, MIB, ICD-10, ICD-10-PCS or ICD-10-CM codes) or synthetic codes are assigned to the data-points. Further, standard industry codes may be translated into proprietary codes (such as Medical Information Bureau (MIB) Codes) for automated processing. For example, standard codes may be mapped to proprietary codes by accessing an MIB database of shared disease codes reported by the insurance industry.

When a coded file is generated, a normalization function may be employed on the coded file to generate a medical report. In one embodiment, a coded file is formatted to a standard code of disease classification, e.g., ICD-10-CM, for an automated insurance underwriting process. For example, the final normalization may be to a symbolic code that represents the disease, such as the ICD-10-CM classification (Z88.0) for an allergy to penicillin. Alternatively, a coded file can be normalized, either automatically, semi-automatically or manually (e.g., by humans), to generate a medical report. The medical report then may be provided to an automated insurance underwriting process (e.g., uploaded to an automated insurance underwriting process via a network or a direct interface connection).

It should be noted that while the one or more steps for processing a medical file are described herein as being distinct processing steps, these divisions are included solely for the purposes of clarity and ease of understanding. Moreover, one skilled in the art will recognize that one or more of the various steps may be consolidated (e.g., into fewer steps) or expanded (e.g., to include one or more additional steps or sub-steps), and that the processing steps presented herein, while exemplary, are not intended to preclude other methods of implementation.

The one or more steps for processing a medical file to generate a medical report are useful for generating a synthetic or engineered pool of underwritten insurance policies, e.g., to provide for a securitized financial instrument or another financial services device.

As described above, insurance underwriters may wish to generate a synthetic or engineered pool of underwritten insurance policies to distribute the risk of underwritten insurance policies, such as in cases where clients are deemed to be uninsurable (e.g., for medical risk that typically cannot be underwritten). Once data regarding a plurality of medical reports is accessible to an insurance underwriter, a normative risk element associated with data in a plurality of normalized medical reports can be identified. A magnitude of the normative risk element can then be determined for each of a plurality of normalized medical reports.

In an embodiment, a plurality of risk performance standards or metrics are generated that correlate with the magnitude of the normative risk element for each of the plurality of medical reports. The plurality of underwritten insurance policies is then associated based on the plurality of risk performance standards or metrics, wherein the plurality of underwritten insurance policies comprise a synthetic or engineered pool of underwritten insurance policies.

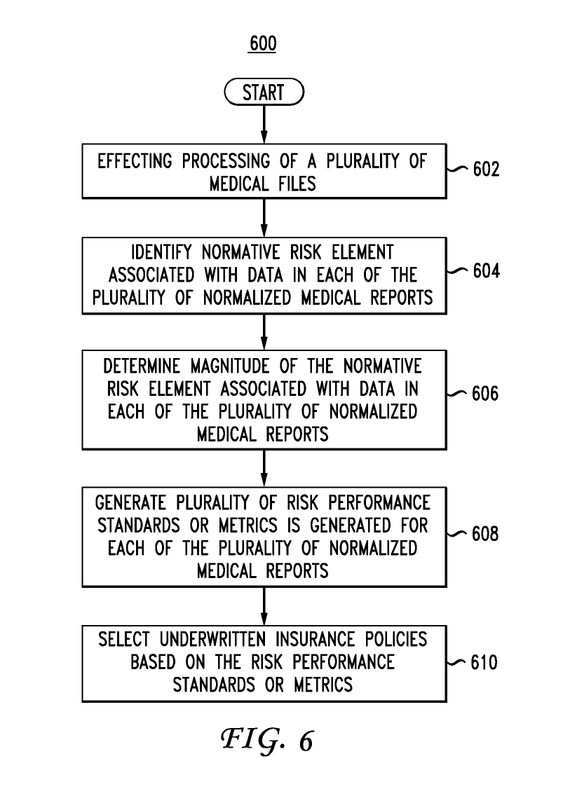

It should be noted that as used in the current context and in the description of FIG. 6 below, a client may include one or more individuals associated with a medical record (e.g., an insured, patient or a patient pool) or an agent of one or more individuals associated with a medical record (e.g., a hospital, an insurance provider or reinsurance provider, an insurance broker, etc.).

FIG. 6 is a flowchart of a process for generating a selected pool of underwritten insurance policies in accordance with an embodiment. Process 600 presents one embodiment of the methods employed for associating underwritten insurance policies. At 602, the process 600 includes effecting processing of a plurality of medical files (associated with one or more individuals) in a shared medical data platform to generate a plurality of normalized medical reports. As described above, normalized medical reports include normalized medical data (e.g., normalized XML data), including one or more critical disease elements. In an embodiment, the normalized medical reports may conform to various insurance data standards, such as one or more Association for Cooperative Operations Research and Development insurance data standards (e.g., the Association for Cooperative Operations Research and Development life insurance data standards). In addition, normalized medical reports may be structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions.

At 604, a normative risk element associated with data in each of the plurality of normalized medical reports is identified. For example, a normative risk element may be associated with normalized medical data including one or more critical disease elements.

A normative risk element also may be further associated with additional data obtained as a result of an insurance underwriting process. Additional data may include correlations determined between the coded files underlying the normalized medical reports. These correlations may include mortality or life expectancy data provided to an automated insurance underwriting process (e.g., along with the normalized medical reports). For example, a life expectancy prediction may be determined based on one or more correlations. Correlations also may be provided for predicting future disease trends.

A magnitude of the normative risk element associated with data in each of the plurality of normalized medical reports is determined at 606. For example, mortality data (e.g., expressed numerically as one or more mortality risk (MR) values) may be determined in association with each of the normalized medical reports.

At 608, a plurality of risk performance standards or metrics is generated for each of the plurality of normalized medical reports. In an embodiment, the plurality of risk performance standards or metrics include values that correlate with the determined magnitude of the normative risk element for each of the plurality of normalized medical reports. For example, the risk performance standards or metrics may be numeric indicators representative of a magnitude of a particular normative risk. Alternatively, the risk performance standards or metrics may be non-numeric indicators (e.g., coded indicators) that correlate to a magnitude or a potential for a particular normative risk.

At 610, underwritten insurance policies (associated with the plurality of normalized medical reports) are selected based on the risk performance standards or metrics, wherein the underwritten insurance policies comprise a synthetic or engineered pool of underwritten insurance policies. A synthetic or engineered pool may be based on either a correlation or a contrast of risk performance metrics between the underwritten insurance policies. The synthetic or engineered pool may be grouped to balance, compliment or offset certain types of risk. As such, a synthetic or engineered pool may be based on balancing risk factors, as well as on grouping together insurance policies with similar risk attributes. For example, an underwritten insurance policy may be either included or excluded from a synthetic or engineered pool based on a value of a risk performance metric.

A synthetic or engineered pool comprising normative risk data collected from normalized medical reports may be created to either balance risk to achieve certain performance goals (e.g., to create a balanced risk synthetic pool) or to carve out and isolate certain risks for underwriting purposes (e.g., to create a special risk synthetic pool). The accuracy of the data in the normalized medical reports makes possible more precise synthetic or engineered pool associations than typical aggregated insurance pools. As such, synthetic or engineered pools can be offered to provide for preferred reinsurance rates or for a securitized financial instrument or another financial services device for attracting risk capital. For example, synthetic or engineered pools may be provided to engineer a AAA rated A Bond and a subordinated B Bond where a first set of investors may receive an insured rate of return based on securitized insurance policies (premium collection), an insurance company may collect a servicing fee and another entity may acquire the subordinated risk portion (the subordinated B bond).

In another example, a synthetic or engineered pool comprising normative risk data collected from normalized medical reports may be created to structure risk within a predefined block of underwritten insurance policies, e.g., a government-defined high-risk block of underwritten insurance policies. As such, a synthetic or engineered pool may be offered to provide for a structured or isolated risk instrument as part of an operation of a health insurance marketplace or exchange, which may be utilized to provide insurance access to particular blocks of customers.

In an embodiment, a consensus underwriting score may be determined across a range of underwriters by retaining a data store of underwriters' specific underwriting criteria, e.g., for a specific disease. For example, stored underwriting criteria may be used to score each of the underwriters for all of the medical conditions in a pool. Such scores then may be used to route synthetic or engineered pools of insurance policies to specific underwriters, e.g., based on an underwriter's score for certain medical conditions.

For example, Underwriter A may rate coronary heart disease (CAD) with 1 blockage of 50% or less as +200% of a (base line) premium. Underwriter B may rate CAD as +300% of the premium. Underwriter C may rate CAD as a decline (no underwriting offer). Underwriter D may rate CAD as +150% of the premium, and Underwriter E may rate CAD as +100% of the premium, if total cholesterol is <150. Underwriter scores (related to the ratings) may be added up for each medical condition (e.g., CAD) in a pool, and pools may be routed to the underwriters with the best scores rather than to low-scoring underwriters offering high premiums or declining coverage.

In an embodiment, a consensus underwriting score may be determined by surveying multiple underwriting procedures or manuals used by underwriters. For example, a structured formula (e.g., throw out lowest and highest scores, and average the remaining scores) may be utilized to determine a consensus underwriting score for a pool. The consensus underwriting score then could be used by brokers to evaluate pricing proposals from underwriters, or for routing pools to particular underwriters (e.g., only to underwriters at or above the consensus score).

Therefore, synthetic or engineered pools may be useful for automated insurance underwriting processes and other applications that require precise underlying medical record data or reliable medical record analytics. Synthetic or engineered pools also may be offered to an insurance underwriter to provide for a securitized financial instrument or another financial services device.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein, including one or more of the steps of FIGS. 2 and 6. Certain steps of the methods described herein, including one or more of the steps of FIGS. 2 and 6, may be performed by a server or by another processor in a network-based cloud-computing system. Certain steps of the methods described herein, including one or more of the steps of FIGS. 2 and 6, may be performed by a client computer in a network-based cloud computing system. The steps of the methods described herein, including one or more of the steps of FIGS. 2 and 6, may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIGS. 2 and 6, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

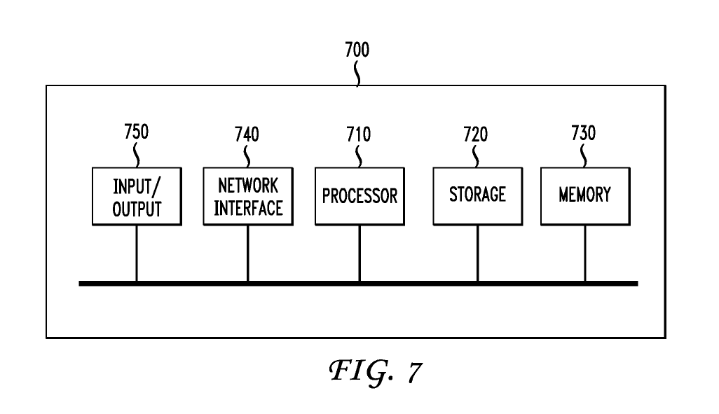

A high-level block diagram of an exemplary computer that may be used to implement systems, apparatus and methods described herein is illustrated in FIG. 7. Computer 700 comprises a processor 710 operatively coupled to a data storage device 720 and a memory 730. Processor 710 controls the overall operation of computer 700 by executing computer program instructions that define such operations. The computer program instructions may be stored in data storage device 720, or other computer readable medium, and loaded into memory 730 when execution of the computer program instructions is desired. Thus, the method steps of FIGS. 2 and 6 can be defined by the computer program instructions stored in memory 730 and/or data storage device 720 and controlled by processor 710 executing the computer program instructions. For example, the computer program instructions can be implemented as computer executable code programmed by one skilled in the art to perform an algorithm defined by the method steps of FIGS. 2 and 6. Accordingly, by executing the computer program instructions, the processor 710 executes an algorithm defined by the method steps of FIGS. 2 and 6. Computer 700 also includes one or more network interfaces 740 for communicating with other devices via a network. Computer 700 also includes one or more input/output devices 750 that enable user interaction with computer 700 (e.g., display, keyboard, mouse, speakers, buttons, etc.).

Processor 710 may include both general and special purpose microprocessors, and may be the sole processor or one of multiple processors of computer 700. Processor 710 may comprise one or more central processing units (CPUs), for example. Processor 610, data storage device 720, and/or memory 730 may include, be supplemented by, or incorporated in, one or more application-specific integrated circuits (ASICs) and/or one or more field programmable gate arrays (FPGAs).

Data storage device 720 and memory 730 each comprise a tangible non-transitory computer readable storage medium. Data storage device 720, and memory 730, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 750 may include peripherals, such as a printer, scanner, display screen, etc. For example, input/output devices 750 may include a display device such as a cathode ray tube (CRT), plasma or liquid crystal display (LCD) monitor for displaying information to the user, a keyboard, and a pointing device such as a mouse or a trackball by which the user can provide input to computer 700.

Any or all of the systems and apparatus discussed herein, including a workflow manager, coding engine and insurance client server may be implemented using a computer such as computer 700.

One skilled in the art will recognize that an implementation of an actual computer or computer system may have other structures and may contain other components as well, and that FIG. 7 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

We claim:

1. A method for generating a selected pool of underwritten insurance policies, the method comprising:
identifying a normative risk element associated with data in a plurality of normalized medical reports;
determining a magnitude of the normative risk element for each of the plurality of normalized medical reports;
generating a plurality of risk performance standards that correlate with the magnitude of the normative risk element for each of the plurality of medical reports; and
selecting a plurality of underwritten insurance policies based on the plurality of risk performance standards, wherein the plurality of underwritten insurance policies comprise one of a synthetic or engineered pool of underwritten insurance policies.

2. The method of claim 1, wherein the normative risk element is further associated with additional data obtained as a result of an insurance underwriting process.

3. The method of claim 1, wherein each of the plurality of underwritten insurance policies in the selected pool is associated with at least one of the plurality of normalized medical reports.

4. The method of claim 1, further comprising excluding an underwritten insurance policy from the selected pool based on a risk performance standard.

5. The method of claim 1, further comprising including an underwritten insurance policy within the selected pool based on a risk performance standard.

6. The method of claim 1, further comprising offering the selected pool to an insurance underwriter to provide for preferred reinsurance rates.

7. The method of claim 1, further comprising offering the selected pool to an insurance underwriter to provide for one of a securitized financial instrument or another financial services device.

8. The method of claim 1, wherein the plurality of normalized medical reports are structurally grouped into categories that include general health information, disease type, symptoms of disease, injuries, general diagnostic testing, biochemistry, microbiology and pathology, imaging, endoscopy, medical procedures and surgeries, medications and prescriptions, family history and restrictions.

9. The method of claim 1, wherein the plurality of normalized medical reports include normalized XML data.

10. The method of claim 1, wherein the plurality of normalized medical reports conform to one or more Association for Cooperative Operations Research and Development insurance data standards.

11. The method of claim 1, wherein the plurality of normalized medical reports include normalized medical data, the normalized medical data including one or more critical disease elements.

12. The method of claim 1, further comprising determining a consensus underwriting score for the selected pool.

13. The method of claim 1, further comprising routing the selected pool to a particular insurance underwriter based on a consensus underwriting score to provide for preferred reinsurance rates.

14. The method of claim 1, further comprising offering the selected pool to provide for a structured or isolated risk instrument as part of an operation of a health insurance marketplace or health insurance exchange.

15. An apparatus for generating a selected pool of underwritten insurance policies, the apparatus comprising:
a data storage device storing computer program instructions; and
a processor communicatively coupled to the data storage device, the processor configured to execute the computer program instructions, which, when executed on the processor, cause the processor to perform operations comprising:
identifying a normative risk element associated with data in a plurality of normalized medical reports;
determining a magnitude of the normative risk element for each of the plurality of normalized medical reports;
generating a plurality of risk performance standards that correlate with the magnitude of the normative risk element for each of the plurality of medical reports; and
selecting a plurality of underwritten insurance policies based on the plurality of risk performance standards, wherein the plurality of underwritten insurance policies comprise one of a synthetic or engineered pool of underwritten insurance policies.

16. The apparatus of claim 15, wherein the normative risk element is further associated with additional data obtained as a result of an insurance underwriting process.

17. The apparatus of claim 15, wherein each of the plurality of underwritten insurance policies in the selected pool is associated with at least one of the plurality of normalized medical reports.

18. The apparatus of claim 15, the operations further comprising excluding an underwritten insurance policy from the selected pool based on a risk performance standard.

19. The apparatus of claim 15, the operations further comprising including an underwritten insurance policy within the selected pool based on a risk performance standard.

20. The apparatus of claim 15, the operations further comprising offering the selected pool to an insurance underwriter to provide for preferred reinsurance rates.

21. The apparatus of claim 15, the operations further comprising offering the selected pool to an insurance underwriter to provide for one of a securitized financial instrument or another financial services device.

22. The apparatus of claim 15, the operations further comprising determining a consensus underwriting score for the selected pool.

23. The apparatus of claim 15, the operations further comprising routing the selected pool to a particular insurance underwriter based on a consensus underwriting score to provide for preferred reinsurance rates.

24. The apparatus of claim 15, the operations further comprising offering the selected pool to provide for a structured or isolated risk instrument as part of an operation of a health insurance marketplace or health insurance exchange.

25. A computer readable medium storing computer program instructions for generating a selected pool of underwritten insurance policies, which, when executed on a processor, cause the processor to perform operations comprising:
identifying a normative risk element associated with data in a plurality of normalized medical reports;
determining a magnitude of the normative risk element for each of the plurality of normalized medical reports;
generating a plurality of risk performance standards that correlate with the magnitude of the normative risk element for each of the plurality of medical reports; and
selecting a plurality of underwritten insurance policies based on the plurality of risk performance standards, wherein the plurality of underwritten insurance policies comprise one of a synthetic or engineered pool of underwritten insurance policies.

26. The computer readable medium of claim 25, wherein the normative risk element is further associated with additional data obtained as a result of an insurance underwriting process.

27. The computer readable medium of claim 25, wherein each of the plurality of underwritten insurance policies in the selected pool is associated with at least one of the plurality of normalized medical reports.

28. The computer readable medium of claim 25, the operations further comprising excluding an underwritten insurance policy from the selected pool based on a risk performance standard.

29. The computer readable medium of claim 25, the operations further comprising including an underwritten insurance policy within the selected pool based on a risk performance standard.

30. The computer readable medium of claim 25, the operations further comprising offering the selected pool to an insurance underwriter to provide for preferred reinsurance rates.

31. The computer readable medium of claim 25, the operations further comprising offering the selected pool to an insurance underwriter to provide for one of a securitized financial instrument or another financial services device.

32. The computer readable medium of claim 25, the operations further comprising determining a consensus underwriting score for the selected pool.

33. The computer readable medium of claim 25, the operations further comprising routing the selected pool to a particular insurance underwriter based on a consensus underwriting score to provide for preferred reinsurance rates.

34. The computer readable medium of claim 25, the operations further comprising offering the selected pool to provide for a structured or isolated risk instrument as part of an operation of a health insurance marketplace or health insurance exchange.
